(19) United States
(12) Patent Application Publication
(10) Pub. No.: US 2008/0192118 A1
(43) Pub. Date: Aug. 14, 2008

(54) Three-Dimensional Surveillance Toolkit

(76) Inventors: Robert K. Rimbold, Bradenton, FL (US); Andrew K. Estes, Sarasota, FL (US)

Correspondence Address: Thomas A. O'Rourke;BODNER & O'ROURKE, L.L.P., 425 Broadhollow Road, Melville, NY, 11747, US

(21) Appl. No.: 11/860,147

(22) Filed: Sep. 24, 2007

Related U.S. Application Data
(60) Provisional application No. 60/846,612, filed on Sep. 22, 2006.

(51) Int. Cl. H04N 7/18

(52) U.S. Cl. 348/159

(57) ABSTRACT

A three dimensional (3D) surveillance toolkit that translates data from a surveillance system for display on a three dimensional map provided by three-dimensional map search engine databases available on the internet. The toolkit includes translation software that provide graphical, geo-spatial representations of alarm and event data that is displayed on three-dimensional map browsers provided by search engine databases available on the internet

### CROSS-REFERENCE TO RELATED APPLICATION

This application claims the benefit of U.S. Provisional Application No. 60/846,612, filed Sep. 22, 2006, the disclosure of which is hereby incorporated by reference herein.

### BACKGROUND OF THE INVENTION

1. Field of the Invention

The present invention relates generally to a three dimensional (3D) surveillance toolkit and more specifically it relates to a toolkit that interfaces surveillance systems to Internet-based three-dimensional (3D), map search engines.

2. Description of the Related Art

Conventional surveillance systems generally involve the use of one or more video cameras, and/or other sensors that provide location of the sensors or objects on two dimensional or three dimensional, custom developed geospatial maps. More advanced surveillance systems provide image analysis and mathematical computations to identify objects of interest, including a person, people, vehicles and vessels. As these surveillance systems have been deployed over large areas, they have incorporated three dimensional (“3D”) maps that display where an object or alarm event is occurring. The drawback is that these 3D maps are custom made with data models that become quickly outdated. Additionally, the maps with the surveillance information require proprietary user interfaces, large computational servers and a significant level of effort to install and maintain.

The advent of Internet search engines (such as TM “Google Earth”) provides three dimensional, geo-spatial registered maps of the entire world, e.g. a virtual world. Users can download a web browser and view an area of interest. The internet search engines also provide the users with application software to dynamically develop 3D data models of physical infrastructures, for example, buildings, fences, water towers, guard towers that are displayed as graphical overlays on the 3D maps. More importantly, the users can access these 3D maps and data models through web browsers without the large computational servers. In effect, the internet search engines are the large computational servers with a world database.

Therefore, it is an object of this invention to provide an improvement which overcomes the aforementioned inadequacies of the prior art devices and provides an improvement which is a significant contribution to the advancement of the surveillance system art.

Another object of this invention is to integrate prior art surveillance systems with modern advances in geospatial display, so that, for instance, targets acquired by the surveillance system can be displayed in real-time in graphical three-dimensional map views, such that an observer can monitor and track targets without need for substantial upfront configuration costs.

Another object of this invention is to gather information from various sensors and ensure that the information additionally includes geographic specific information relative to the original information produced by the sensor, such that other devices and applications, including databases, artificial intelligence applications, graphical displays, etc. can seamlessly integrate with and utilize this expanded information.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF INVENTION

The general purpose of the 3D surveillance toolkit is to facilitate communication and interoperability between surveillance equipment. The product of this offering enables seamless integration of existing surveillance equipment components. Surveillance equipment components comes in many different types, which each serve distinctive purposes. Some surveillance equipment components, such as video cameras, pan-and-tilt cameras, and heat cameras perform their surveillance activities by gathering imagery and providing that imagery to another device, such as a monitor for display. Other surveillance equipment components, such as a ground sensor, simply determines whether or not a condition is satisfied. In the case of the ground sensor, the sensor could indicate that the ground is currently shaking, or that it is not. Of course, these descriptions are merely exemplary of what is known in the art, and any sensing device would satisfy the criteria herein.

By way of background, these prior art components currently are able to communicate over various communication protocols. Typically, these communication protocols are proprietary and highly customized, making difficult the process of integrating various components with different protocols. Additionally, these components do not provide a standard set of information, which lends difficulty to integrating these complex devices.

The teachings of the present invention overcome these and many other shortcomings by creating a common data model in which these components can communicate. Additionally, and as a feature of this data model, geographic information is included concerning all communications performed utilizing this data model. As will be explained below, due to the needs of the surveillance industry, the addition of geographic information to the data provided by these surveillance components adds substantial functionality.

A primary improvement over prior surveillance systems is most notable when analyzing the display of surveillance information. Because geographic information is included with all information exchanged under the present invention, a vast improvement in display of surveillance data can be had. More specifically, the information exchanged within the present invention can be shared with a device that is capable of displaying geographic information on a map. A commercial prior art display system includes TM “Google Earth” provided by Google, Inc. The TM “Google Earth” application receives as its input geographic information, and displays the geographic information received properly overlaid upon a map of the respective area. Thus, utilizing the improvements taught herein, surveillance equipment components will not only report what surveillance information they have obtained, but will also report where that surveillance information is located. By enabling applications such as TM “Google Earth” to interact with this surveillance information, the same can be displayed easily in an intuitive interface.

For example, a video camera can be positioned to determine intruders that might attempt to enter a building. In prior systems, when the intruders were in the range of view of the camera, this information would be displayed on a preconfigured monitor. A user, such as a security guard, would be provided an image, as well as information indicating which camera provided the image. The guard would then consult a diagram which would indicate where the camera providing the image was located. Alternatively, an electronic diagram could be hand configured to provide a similar report. However, in prior systems, such electronic diagrams required a tremendous amount of customization and configuration. The guard would then have the necessary information to dispatch an appropriate response.

Under the teachings of the present invention, the video camera would not only report the images it had captured, but would also report the location of the video camera, as well as the computed location of the intruders. Thus, when this communication is received, it can easily be passed to a display device, such as TM “Google Earth,” for a meaningful display. In this case, the guard will be presented with a map view of the area under surveillance, with video or other indication of where the intruders have attempted the act of intrusion.

Additionally, under the common data model explained herein, all components existing on the system can receive and send properly formatted communications. Thus, each device can react to any event. Following the example above where a video camera detected an intruder, the process could go as follows. First, the video camera would send a message utilizing the common data model, indicating an intruder had entered, and providing the location of the camera and the intruder. In the above example, one of the recipients of the message converted the information so as to be displayed by TM “Google Earth.” Additionally, a pan-and-tilt camera could be another piece of surveillance equipment capable of receiving messages within this system. Upon receipt of the first video camera's message, the software on the pan-and-tilt camera could determine to reposition the pan-and-tilt camera to attempt to acquire a different view of the intruders.

The current invention overcomes the limitations in the prior art by including geographic information about the sensing device and the targets detected by the sensing device. Thus, in the example above, when the video camera detects a person, it not only indicates how far away the person is from the camera, but it also knows where, geographically, the camera is located. One way of maintaining and distributing this information would be by indicating the camera's latitude and longitude. Thus, when the camera in the above example reports an intruder is a certain distance away from the camera at a certain angle, the toolkit can determine the geographic coordinates of the detected target. This allows the information to be generated by the toolkit to include information pertaining to the geographic location of detected intruders.

Thus, the entire system is comprised of several different types of modules, each of which communicate over a network using a common data model. The actual type of network is not relevant, but could be any known network, such as Ethernet, TCP/IP, RF, light-wave, or cable.

Sensors are integrated into the system of the present invention through a Sensor Processing Module (“SPM”). The SPM is preferably software and/or hardware that converts the output from the sensor, into network messages that implement the common data model discussed herein.

As discussed above, the SPM also ensures that geographic information pertaining the respective sensor is included in each sent message. Some sensors contain hardware allowing it to automatically determine the sensor's location. For example, if a sensor includes a Global Positioning System (“GPS”) device, the SPM can query this device to determine the sensor's location. Other sensors do not have such devices, and thus require manual input of that geographic information during setup configuration of the sensor. Additionally, a GPS device could be integrated into the SPM so that the SPM can query the location of the SPM when this information is required.

Similarly, some sensors report geographic location of targets (for instance, radar does this), while others rely upon the interface software to provide that information. When the SPM is required to determine the geographic location of targets, it follows these steps: First, it gathers the absolute geographic location of the sensor, as discussed above. Thus, if the sensor is one that includes a GPS device, the SPM queries the GPS device for the sensor's absolute geographic location. Second, the SPM gathers the relative location of the target from the sensor. Sensors provide this information in a number of fashions. For instance, some video sensors that detect targets report information including how far the target is from the video sensor. Others, such as certain ground sensors, can only detect events within a certain range of operability. The SPM utilizes this information provided by the sensor to determine the target's absolute geographic location.

Regardless of the type of device, the SPM will create outgoing messages that contain appropriate geographic information. For some devices, the SPM is merely a translation engine that converts data from the sensor's native output format into the format used by the common data model. For other devices, the SPM does further computation before creating network messages, as discussed above.

The SPM also handles incoming network messages. The data network supports a highly distributed computational model, in which each SPM is responsible for taking appropriate action upon receipt of messages from other modules.

A common message type that an SPM would receive from a User Interface Module (discussed below) would be a Command message. The SPM would execute the requested command, if it is able. The supported commands are extensible, as a feature of the data model. Typical commands include instructions to go on/offline, start/stop tracking, reply with status, etc.

Common message types that an SPM would receive from another SPM include Alarm Event and Target messages. The SPM has the flexibility to command the sensor it controls in response to these messages from other SPMs. It may instruct a camera to turn and look at the location of a target generated by another nearby sensors, as an example.

The availability of geographic location in the messages allows for sophisticated distributed sensor handling. A central operator need not be responsible for the control of each sensor directly, and each sensor may respond automatically to events at other sensors.

A User Interface Module provides a task-specific representation of the data flowing through the network. It may be a simple as monitoring the level of network bandwidth currently in use, or as complex as the real-time display of target locations in a 3D geographic representation that TM “Google Earth” provides.

TM “Google Earth” uses a data file as a source of locations for the display of user-specified data. The present invention allows for the easy creation of such a data file, at frequent intervals, using the locations of targets generated by sensors in the network. It extracts the geographic location, velocity, and other target-specific information from each target message, and writes the information to the data file in the format expected by TM “Google Earth.” A person reasonably skilled in the art would appreciate that the User Interface Module could be implemented in different ways, and thus the discussion of utilizing TM “Google Earth” is merely exemplary.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is high-level block diagram of the invention;

FIG. 2 is a diagram of the invention depicting the interoperability of a number of components;

FIG. 3 is a top-level diagram depicting a usage scenario under the present invention; and

FIG. 4 is a screen shot demonstrating the display of surveillance information under the present invention.

Similar reference characters refer to similar parts throughout the several views of the drawings.

### DETAILED DESCRIPTION OF THE PREFERRED EMBODIMENT

### Definitions

In describing the invention, the following definitions are applicable throughout (including above).

A “computer” refers to any apparatus that is capable of accepting a structured input, processing the structured input according to prescribed rules, and producing results of the processing as output. Examples of a computer include a computer; a general-purpose computer; a supercomputer; a mainframe; a super mini-computer; a mini-computer; a workstation; a microcomputer; a server; an interactive television; a hybrid combination of a computer and an interactive television; encoders, embedded systems, special-purpose computers and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

“Software” refers to prescribed rules to operate a computer. Examples of software include software; code segments; instruct ions; computer programs; and programmed logic.

A “computer system” refers to a system having a computer, where the computer embodying software to operate the computer.

A “network” refers to a number of computers and associated devices that are connected by communication facilities. A network involves permanent connections such as cables or temporary connections such as those made through telephone or other communication links. Examples of a network include an internet, such as the Internet; an intranet; a local area network (LAN); a wide area network (WAN); a satellite link, a RF link, an encoded transmission link, a dedicated transmission link and a combination of networks, such as an internet and an intranet.

“Snapshot” refers to a single motion picture represented in analog and/or digital form. Examples of a snapshot include image sequences from a camera or other observer, and computer-generated image sequences. These can be obtained from, for example, a live feed, a storage device, an IEEE 1394-based interface, a video digitizer, a computer graphics engine, a computer, or a network connection to a particular image or other discrete unit within a video.

“Video” refers to motion pictures represented in analog and/or digital form. Examples of video include television, movies, image sequences from a camera or other observer, and computer-generated image sequences. These can be obtained from, for example, a live feed, a storage device, an IEEE 1394-based interface, a video digitizer, a computer graphics engine, a computer, or a network connection.

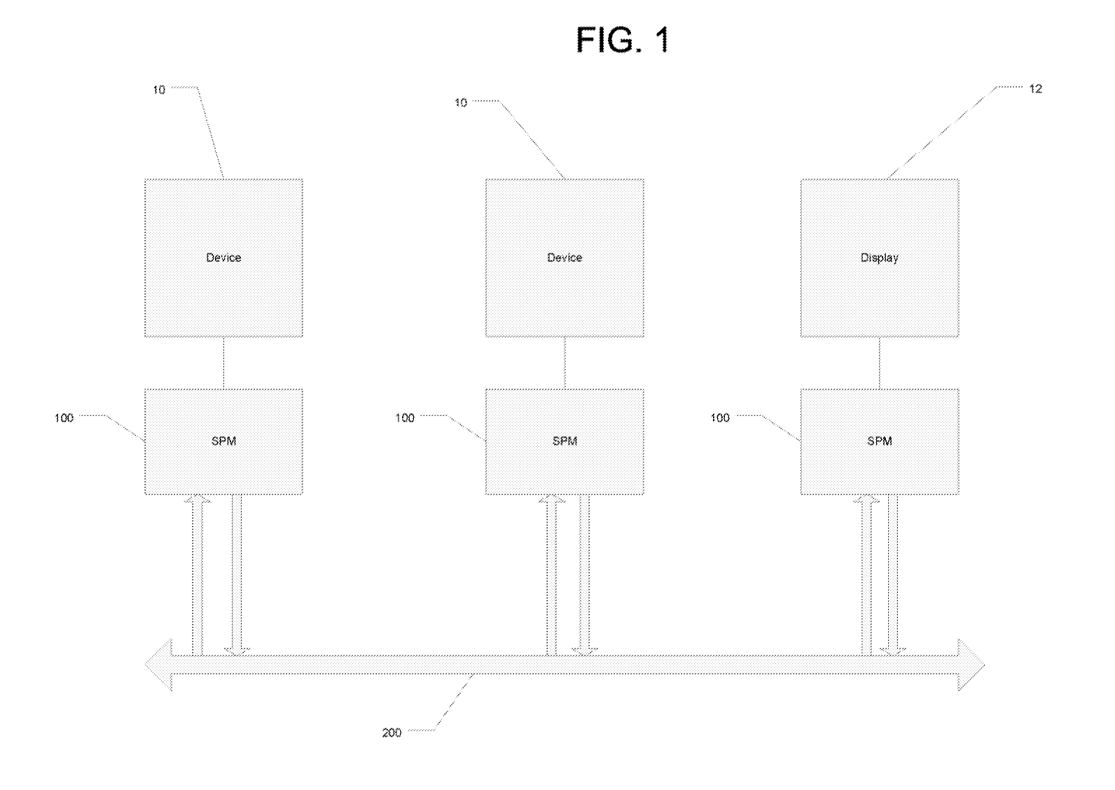

FIG. 1 is a high-level diagram depicting the invention. The SPM 100, which is preferably implemented in software, communicates with various devices 10. Surveillance devices 10 can be any sensing device, such as video cameras, pan-and-tilt cameras, seismic detectors, radar, thermal detectors, sonograms, sound-based detectors, infrared-based detectors, seismic detectors, ground sensors, biological sensors, chemical sensors, or any other sensing device.

Typically, device 10 outputs information pertaining to its sensing purpose. In the case of a video sensing device, such as a video camera, pan-and-tilt camera, and pan-tilt-zoom camera, the device outputs video information, which could be single images, or frames of images. In the case of a ground sensor, the information output could be an on/off value, where on indicates the ground sensor detects movement on the ground, while off indicates the opposite. Prior to the teachings of the current invention, these outputs from the various sensing devices were delivered to a central monitoring facility, or a number of monitoring facilities. During the installation and configuration of these prior systems, the outputs from the various sensing devices is mapped to some form of indicator. For instance, when a video camera is installed in the northwest quadrant of a building, some document is maintained so that whomever monitors the video feed from the video camera knows where the camera is positioned. The SPM 100, however, ensures that sensor specific, and target specific, geographic information is included with all output from the device 10.

As shown on the right part of FIG. 1, SPM 100 can also be connected to a User Interface 12. As discussed above, the primary purposes of the SPMs 100 is to implement the common data model utilized for the present invention. The SPMs 100 communicate with each other via the communication medium 200. Communication medium 200 may be a cable, TCP/IP, Ethernet, RF, a network, satellite transmission, or light-wave or any other communication medium.

The system operates by way of messages exchanged between and among the various SPMs. A preferable model to implement the communications within the system is the event model. Under the event model, when a component comes online, it notifies other components of its existence. This is typically accomplished via a register message sent by the component indicating its availability to participate in the system.

Once online, the various components each send and receive messages. Each component acts as both a publisher of information when it sends messages, and a subscriber to information when it receives messages. The types and objectives of various messages are discussed in more detail below. A preferable way of implementing these messages is by encoding them in a binary format to minimize bandwidth usage. An alternative way of implementing these messages is by encoding them utilizing the extensible Markup Language (XML).

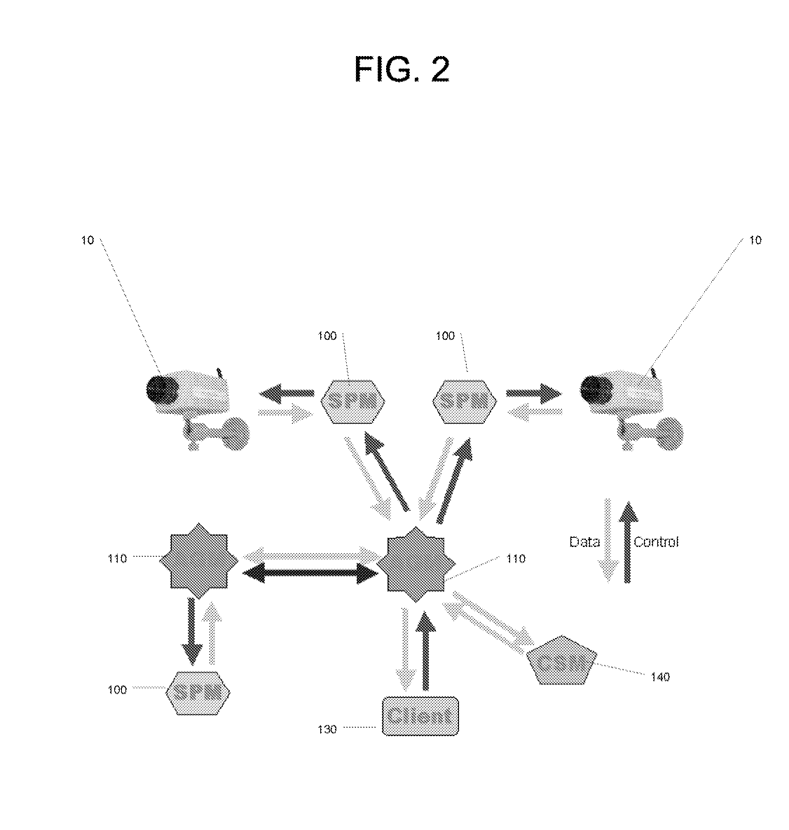

FIG. 2 depicts the interactions of the various components of the present system. As depicted, two video camera devices 10 are integrated with respective SPMs 100. The SPMs 100 each interact with Archive Gateway Modules (“AGM”) 110. The AGMs 110 are responsible for aggregating results from various SPMs 100 as well as intercommunicating with other devices. These other devices could be other AGMs 110 (as depicted on the left part of FIG. 2), or client applications 130. Additionally, a Control Status Module (“CSM”) 140 can communicate with an AGM 110. The CSM 140 provides user authorization and authentication capabilities for the system, so that messages and events can be verified and authenticated.

To discuss the AGM 110 in more detail, the AGM 110 is a gateway for inter-module communication. The AGM 110 is responsible for maintaining connectivity between the modules currently connected to it. This enables the event model to properly function, as the SPMs 100 communicate their respective events to the AGM 110. The AGM 110, in turn, then verifies the messages get delivered to all necessary recipients.

The types of messages exchanged by the present system generally fall into two categories: (1) control messages; and (2) data messages. Control messages are utilized for controlling the various components of the present system, such as registering for receipt or non-receipt of certain types of events, performing a roll call to determine which SPMs are available, handling alarms, enabling or disabling a sensing device, and resetting sensors. Data messages are utilized for sending data specific to the surveillance tasks of the respective components, such as imagery from a video sensor, alarms, and target information.

SPMs register with the system by first sending an appropriate message. This message announces the SPMs availability to participate in the system. If this registration process succeeds, the SPM will receive a successful registration message in return, so that it knows it is active in the system.

Immediately upon registration, the SPM sends a message containing information specific to the sensor the SPM is integrated with. This message can include the following information: Sensor ID, Camera Range, Status, Error correction, Position, Height above ground, Region of responsibility, Field of view, Image information, Limits, and Type.

The Sensor ID is a unique identifier indicating the sensor. The Camera Range is an optional piece of information. It provides the sensor's maximum detection range and can be reported in any measurement value. Preferably, Camera Range is reported as the range of the camera in meters.

The Status field reports on the status of the sensing device. It can indicate an extensible amount of information concerning the sensor's status such as whether the sensing device is being powered from its backup battery or not; if the sensor contains an internal disk, whether or not the internal disk is almost full; the temperature of the sensor; and whether the sensor is online or offline.

Error correction information can be applied to a location of a sensor to make certain corrections. This information is provided as a 3-tuple: altitude, latitude and longitude. The altitude is the elevation correction, preferably provided in meters. The latitude and longitude are the coordinates of correction.

The Position information provides the GPS location of the sensor. As with the Error correction information, the Position is provided as a 3-tuple: altitude, latitude and longitude. Optionally, Height above ground information can be provided. This information reports, preferably in meters, how far above the ground the sensor is positioned.

The sensor can also report on its region of responsibility. This region of responsibility describes the area where the sensor can reliably perform detection. The SPM reports this information as a polygon of coordinates, where the polygon indicates what the region of responsibility is. To report this, the SPM constructs a list of GPS coordinates, which each represent a vertex of the polygon representing the region of responsibility.

The sensor can also provide its Field of view through a similar approach. The field of view can be provided as the vertical and horizontal angles that the sensor is capable of viewing. The field of view can also include a polygon describing the field of view of the sensor. As above, this polygon would be transmitted to the system as a list of GPS coordinates, each representing a vertex of the polygon.

The sensor can also report on the images it can produce. This information can be provided as the resolution of imagery generated by the sensor. Additionally, when the sensor is a pan-tilt-zoom camera (“PTZ”), the sensor can report on the limits of movement of the PTZ, as well as the position of the PTZ. The limits of movement of the PTZ preferably describe the bottom right and top left degrees of the PTZ. These degrees are reported as a 2-tuple: pan degrees and tilt degrees. The PTZ limit information also includes the maximum and minimum horizontal fields of view. To report on the PTZ position, the message includes the pan angle, tilt angle, twist and current zoom of the PTZ.

The Type information reported indicates what type of sensor is sending the message.

Once the SPM is registered, it enters the main functional loop. During this time, the SPM manages four main operations: (1) Updating information about the sensor as needed; (2) generating messages concerning targets, (3) generating alarm messages; and (4) responding to command messages.

When information about the sensor changes, the SPM reports this information. Such information changes could be when a PTZ moves, or when the sensor's location changes. By sending this message, the SPM keeps all other components, including any components utilized for displaying information, apprised of the current information about the sensor's positioning and status information.

The sensing devices are capable of detecting targets, and in some instances monitoring targets. For instance, when a ground sensor is activated, it is considered to have detected a target. Similarly, when a video camera detects an intruder, it has detected a target. When the sensor detects a target, the SPM sends a Target message containing pertinent details about the target.

Each target is provided a unique identifier, which enables the various components to coordinate their interactions with targets. The Target message can include the following information: Timeout, Bounding box; Direction; Image position; GPS Position; Label; Priority; Size; Speed; Status; and Type.

The Timeout information is a duration after which the target should be considered to be lost or inactive. Thus, if an SPM reports a target with a timeout of 5 milliseconds, after 5 milliseconds, a display device that has indicated the location of this target should remove the indicator.

The Bounding Box can optionally be included in the message. This bounding box describes a box which would contain the target. This is useful in highlighting the target's location in accompanying imagery. This information is provided as vertex information for the bottom right and top left coordinates of the bounding box.

The SPM can also report on the direction of the target's motion. This directional information represents the compass degrees of the target's heading. The SPM and other modules, including User Interface Modules, can utilize this direction information to deduce where the target will be after certain intervals, and update the displays accordingly. (To accomplish this, the velocity of the target is also utilized.)

If the sensor provides an image, such as a video camera sensor, the Target message can also indicate the location of the target within the image that is provided. This image location information is provided as the coordinates within the image of the identified target.

The SPM can also include the GPS position of the target in the Target message. As with other messages, this GPS information is a 3-tuple of altitude, latitude and longitude.

The SPM can also include a string label with the Target message. This label can be used for a number of purposes, including displaying a character string associated with the Target event.

Targets can also be prioritized, which is why the Target message can optionally include a Priority field. The SPM can also report on the size of the target. For video sensors, the size of the target is the area of the target.

The SPM can additionally include the speed of the target. The speed is preferably reported in meters per second. As mentioned above, this speed information can be combined with the direction information for a number of tasks. As each SPM not only sends messages, but also receives messages, the following scenario, described by way of an example, is envisioned by the present teaching.

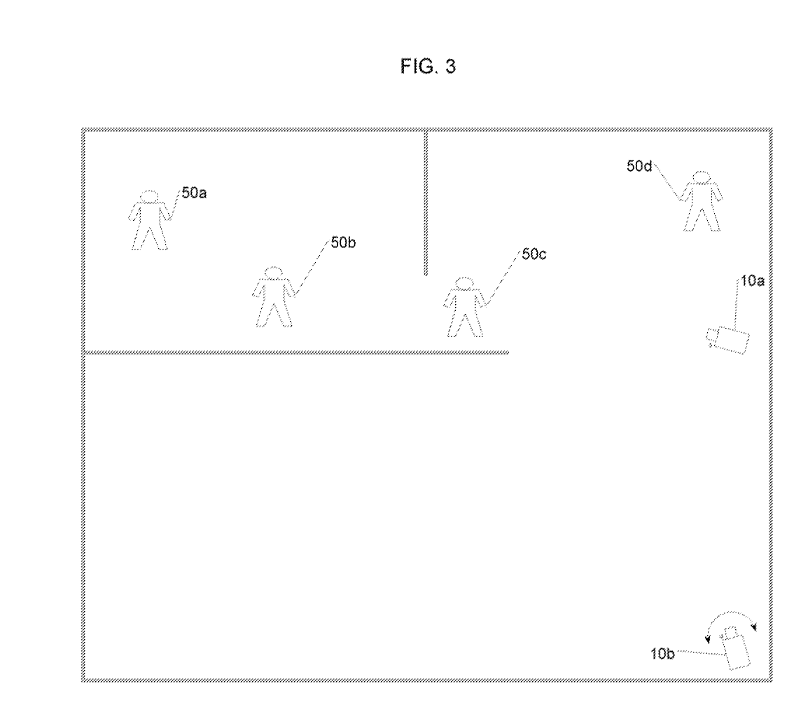

FIG. 3 is useful in describing this scenario. In FIG. 3, there are two surveillance devices: a fixed position camera 10a and a PTZ 10b. As indicated, there is also an intruder 50. When the intruder 50 is at position 50a, the intruder is in the field of view of camera 10a, but PTZ 10b can not see the intruder due to a n obstructing wall. When intruder 50 has moved to position 50b, camera 10a has been able to determine the intruders 50 size, location, speed, and direction of movement. This information is broadcast to the system by the SPM 100 integrated with camera 10a (not depicted in FIG. 3). Because the SPM 100 integrated with PTZ 10b receives these Target messages from camera 10a, it determines that the intruder will soon be in PTZ's 10b field of view. The SPM 100 integrated with PTZ 10b is capable of doing this because it is aware of PTZ's 10a field of view, as discussed above. Thus, the SPM 100 integrated with PTZ 10b instructs the PTZ 10b to rotate and reposition itself so that it can acquire imagery of intruder 50. As shown at position 50c, camera 10a is no longer capable of seeing intruder 50, because intruder 50 is outside the field of view of the camera 10. But, PTZ 10b has repositioned itself and continues to provide target information concerning the intruder 50.

Returning to a description of the Target message, the message should also include a status identifier. This indicates certain information on the tracking and targeting of the target, such as whether or not the sensor an confirm it has detected a target, whether it has lost the target, whether the target is moving or stationary, whether the target is loitering, etc.

The Target message can also include information about the type of the target, such as whether the target is human or not, whether the target is a car, and if so what kind, etc.

The next type of message generated by the SPM during the main functional loop is the Alarm message. The Alarm message is broadcast to all objects on the network, which allows them to process it appropriately. Any object on the network can choose to ignore this message. In the example discussed above in relation to FIG. 3, when camera 10a initially detected intruder 50, it could have generated an Alarm message to indicate this intrusion.

The Alarm message can include the following information: Priority, Type, Identifier, Image, Sensor, Target, and Time. As above, the priority information is utilized for having different priority alarms. The type element is used to provide information in the type of alarm at issue, such as an intruder loitering, a car alarm, an entry or exit point, etc. The Identifier is used to uniquely identify the alarm.

If the sensor is a video sensor, it can also include an image with the Alarm message. The image is a snapshot taken from the video sensor and included as part of the message. In these cases, the SPM includes additional information about the image, such as the image size, encoded information about the image, such as encoded JPEG image data, and the position of the target within the image. The position of the target within the image is preferably provided as the x- and y-coordinates of the target's location within the image.

The Alarm message also includes information on the sensor that generated the message. This information includes the GPS location of the sensor (again provided as the 3-tuple of the altitude, latitude and longitude of the sensor), the sensor's identifier, and the sensor's field of view.

The Alarm message also provides additional information about the target that caused the alarm. This includes the corrected size of the target, the GPS location of the target, an identifier for the target, an image trajectory for the target and the trajectory of the target. The image trajectory of the target is the last location in the image where the target was previously located. This is provided as the x-y coordinates within the image. The trajectory information is the last location in geospatial coordinates where the target was previously located. This information is provided as the 3-tupe (altitude, latitude and longitude).

The fourth category of messages handled during the main functional loop are the control messages. These messages are utilized for a number of purposes, including determining which sensors are online, bringing sensors online and offline, disabling or enabling the tracking capabilities of the sensors, resetting the sensors, or any other control capabilities.

Many of the benefits of the current invention are evident when considering the user interfaces utilized for displaying the surveillance information gathered by various surveillance equipment. One drawback to prior approaches is the tremendous amount of customizations necessary to operate and configure such a system. More importantly, the sensors and video source devices are unaware of their position particularly as it relates to the rest of the world. For instance, sensors and video source devices of prior systems may be connected to a user display, where the user display is manually configured to know generally where each sensor or video device is. If a sensor or video device is moved, the user display will need to be manually reconfigured. Additionally, these sensors and video source devices are unable to provide geographic information concerning targets that are identified by the respective sensors.

An example would be helpful. A seismic sensor would detect when there is movement around the sensor. But with prior systems, these sensors do not know where they are, so what they report to the user interface is only an alarm condition. The user interface has been manually configured to deduce an approximate location of the sensor. Similarly, a video sensor would not have the understanding of knowing where it was. Thus, when the video sensor detected a target, the video sensor would be unable to determine any geographic information concerning the target.

Returning to FIG. 2, the Client 130 can be the User Interface Module. As discussed above, the Client 130 registers itself with the AGM 110 and listens to all messages exchanged. As the User Interface Module's role is to display targets and alarms, it pays particular attention to those events. One preferable way of providing a intuitive user interface is through the use of TM “Google Earth” or any other display software capable of positioning elements on a map based upon their geographic coordinates.

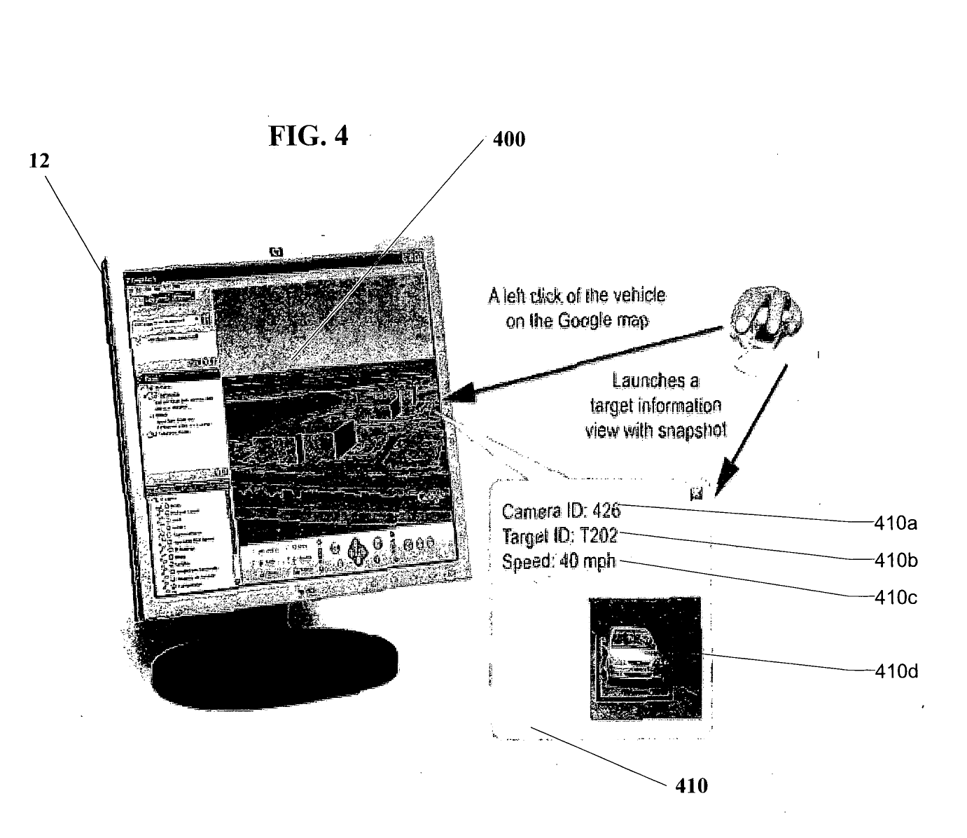

As discussed at length above, target and alarm information includes GPS information pertaining to the respective target's location. The Client 130 module can receive these target and alarm messages and provide the respective location information to the display software, such as TM “Google Earth.” Additionally, when providing this information to the display module, the Client 130 can associate the respective sensor data and information with the target's location. This is depicted in FIG. 4.

In FIG. 4, a display 12 is provided which displays information provided to the display 12 from its respective Client 130 interface to the system herein (not depicted). As indicated at callout 410, the display 12 provides information from the sensing device that generated this alarm, such as the sensor device identifier 410a, the target identifier 410b, the speed of the target 410c, and an image snapshot from the camera depicting the target 410d. Note also that display 12 presents this information to the user by way of a map 400 depicting the general area under surveillance. Thus, the callout 410 is positioned on the map 400 so as to represent where the target is located.

There are any number of ways of displaying target and alarm information on the map 400 such as: icons, flashing polygons, video, snapshots, or any other way of displaying such information. The display 12 may also indicate any textual data that was provided by way of any of the messages and include this information on the map 400.

Embodiments of this invention may include surveillance data, such as the video images captured by the video sensor devices, as well as alarm messages from the SPMs 100 that are outputted and displayed on cell phones, or personal design assistants (PDA's).

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A system for integrating surveillance system components comprising:
a plurality of sensing devices which each output information whereby the information output comprises:
geographic information representing a location of the sensing device including altitude, latitude, and longitude; and
target information representing a target identified by the sensing device whereby the target information comprises the distance from the target to the sensing device;
a toolkit which receives the target information and the geographic information from the sensing device and calculates a geographic information of the target including altitude, latitude, and longitude; and
a receiver that receives the geographic information of the target from the toolkit.

2. The system of claim 1, whereby the receiver comprises a three-dimensional map and the receiver displays the target information on the three-dimensional map such that the target information is positioned on the three-dimensional map so as to correspond to the geographic information of the target.

3. The system of claim 2, whereby the receiver displays the target information on the three-dimensional map as an icon.

4. The system of claim 2, whereby the receiver displays the target information on the three-dimensional map as an image.

5. The system of claim 2, whereby the receiver displays the target information on the three-dimensional map as a movie.

6. The system of claim 1, whereby the plurality of sensing devices comprises a plurality of video cameras.

7. The system of claim 1, whereby the plurality of sensing devices comprises a plurality of pan-tilt-zoom cameras.

8. The system of claim 1, whereby the plurality of sensing devices comprises a plurality of thermal cameras

9. The system of claim 1, whereby the plurality of sensing devices comprises a plurality of heat-based sensors.

10. The system of claim 1, whereby the plurality of sensing devices comprises a plurality of radar.

11. The system of claim 1, whereby the plurality of sensing devices comprises a plurality of ground sensors.

12. The system of claim 1, whereby the plurality of sensing devices comprises a plurality of biological sensors.

13. The system of claim 1, whereby the target information further comprises the direction of the target identified.

14. The system of claim 1, whereby the target information further comprises the velocity of the target identified.

15. The system of claim 1, whereby the target information further comprises the trajectory of the target identified.

16. The system of claim 1, whereby the information output by the plurality sensing devices further comprises the field of view of the sensing device.

17. The system of claim 1, whereby the information output by the plurality sensing devices further comprises the range of detection of the sensing device.

18. The system of claim 1, whereby the information output by the plurality sensing devices further comprises video frames.

19. A surveillance system comprising:
a plurality of sensors which broadcast and receive messages on a communication medium, each sensor being integrated with a toolkit which ensures that the messages broadcast by the sensor includes geographic information corresponding to an absolute location of sensors;
a user interface module which broadcasts and receives messages on the communication medium and displays the message on a map in a position corresponding to the absolute location of the sensor.

20. The surveillance system of claim 19, whereby the messages further comprise a video image captured by the sensor and the user interface displays the image on the map in a position corresponding to the absolute location of the sensor.

21. The surveillance system of claim 19, whereby the messages further comprise a video image captured by the sensor, and the toolkit further ensures that the messages broadcast by the sensor include geographic information corresponding to an absolute location of the image captured by the sensor; and
the user interface displays the image on the map in a position corresponding to the absolute location of the image.

22. The surveillance system of claim 19, whereby the messages further comprise a video image captured by the sensor, the video image containing a target, and the toolkit further ensures that the messages broadcast by the sensor include geographic information corresponding to an absolute location of the target contained in the video image; and
the user interface display the image on the map in a position corresponding to the absolute location of the target contained in the video image.

23. A surveillance method comprising the steps of: interfacing a plurality of sensors which broadcast and receive messages on a communication medium with a user interface which broadcasts and receives messages on the communication medium and displays the message on a map in a position corresponding to the absolute location of the sensor.

24. The surveillance method of claim 23, wherein said interface comprises a toolkit which ensures that the messages broadcast by the sensor includes geographic information corresponding to an absolute location of sensors.

25. The surveillance method of claim 24, wherein the messages further comprise a video image captured by the sensor and the user interface displays the image on the map in a position corresponding to the absolute location of the sensor.

26. The surveillance method of claim 25, wherein the messages further comprise a video image captured by the sensor and the toolkit further ensures that the messages broadcast by the sensor include geographic information corresponding to an absolute location of the image captured by the sensor; and
the user interface displays the image on the map in a position corresponding to the absolute location of the image.

27. The surveillance method of claim 25, wherein the messages further comprise a video image captured by the sensor, the video image containing a target, and the toolkit further ensures that the messages broadcast by the sensor include geographic information corresponding to an absolute location of the target contained in the video image; and
the user interface displays the image on the map in a position corresponding to the absolute location of the target contained in the video image.
